(19) United States
(12) Patent Application Publication
(10) Pub. No.: US 2024/0090974 A1
(43) Pub. Date: Mar. 21, 2024

(54) DENTAL RESTORATION AND METHOD OF FORMING THEREOF

(71) Applicant: 3M INNOVATIVE PROPERTIES COMPANY, St. Paul, MN (US)

(72) Inventors: Malte Korten, Moorenweis (DE); Bastian P. Kirchner, Fuerstenfeldbruck (DE); Christian A. Richter, Feldafing (DE); Gioacchino Raia, Tuerkenfeld (DE); Bernhard C. Hofmann, Peißenberg (DE); Rudolf Schmid, Eichenau (DE)

(21) Appl. No.: 18/264,134

(22) PCT Filed: Mar. 2, 2022
(86) PCT No.: PCT/IB2022/051842

§ 371 Date: Aug. 3, 2023

(30) Foreign Application Priority Data
Mar. 10, 2021 (EP) 21161669.3

(51) Int. Cl. A61C 5/77; A61C 9/00; A61C 13/00; B33Y 50/00; B33Y 80/00

(52) U.S. Cl. CPC A61C 5/77; A61C 9/0053; A61C 13/0004; A61C 13/0019; B33Y 50/00; B33Y 80/00

(57) ABSTRACT

A method of forming a dental restoration for a tooth having an outer surface includes acquiring a first three-dimensional representation representative of the outer surface of the tooth; generating a design of a first part of the dental restoration based on the first three-dimensional representation of the tooth; forming the first part of the dental restoration; preparing the tooth to form a prepared tooth while forming the first part of the dental restoration; obtaining a second three-dimensional representation of the prepared tooth; generating a design of a second part of the dental restoration based on at least the second three-dimensional representation of the prepared tooth; merging the design of the second part of the dental restoration to the first part of the dental restoration; and forming the second part of the dental restoration.

### TECHNICAL FIELD

The present disclosure relates generally to a dental restoration and a method of forming such dental restoration.

### BACKGROUND

In conventional methods of forming a custom dental restoration, a tooth is first prepared (e.g., ground to a tooth stump). In some cases, multiple teeth may be subject to dental restoration and prepared accordingly. An intraoral cavity including the prepared tooth is then digitally scanned to determine dimensions of the prepared tooth in order to generate a design of the custom dental appliance. The design of the custom dental appliance may be used to form the custom dental appliance.

### SUMMARY

Generally, the present disclosure relates to a dental restoration. The present disclosure also relates to a method of forming such dental restoration.

In a first aspect, the present disclosure provides a method of forming a dental restoration for a tooth having an outer surface. The method includes acquiring a first three-dimensional representation representative of the outer surface of the tooth. The method further includes generating a design of a first part of the dental restoration based on the first three-dimensional representation of the tooth. The first part includes a first outer surface substantially conforming to at least a first portion of the outer surface of the tooth and a first inner surface spaced apart from the first outer surface. The first inner surface of the first part defines an inner cavity. The method further includes forming the first part of the dental restoration. The method further includes preparing the tooth to form a prepared tooth while forming the first part of the dental restoration. The method further includes obtaining a second three-dimensional representation of the prepared tooth. The method further includes generating a design of a second part of the dental restoration based on at least the second three-dimensional representation of the prepared tooth. The second part of the dental restoration is disposed adjacent to the first part of the dental restoration. The method further includes merging the design of the second part of the dental restoration to the first part of the dental restoration. The method further includes forming the second part of the dental restoration.

In a second aspect, the present disclosure provides a dental restoration for a tooth having an outer surface, the tooth being prepared to form a prepared tooth for receiving the dental restoration. The dental restoration includes a first part including a first outer surface and a first inner surface spaced apart from the first outer surface. The first outer surface conforms to at least a first portion of the outer surface of the tooth. The first inner surface defines an inner cavity. The dental restoration further includes a second part disposed adjacent to the first part. The second part includes a second outer surface contiguous with the first outer surface and a second inner surface spaced apart from the second outer surface and contiguous with the first inner surface. The second inner surface defines an opening therethrough disposed in fluid communication with the inner cavity of the first part. The opening is configured to at least partially receive a tooth stump of the prepared tooth therein. The second inner surface is offset from the tooth stump by a substantially constant gap along a length of the opening. A first ratio of a volume of the inner cavity to a volume of the substantially constant gap is greater than or equal to 2.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 shows a schematic view of an exemplary tooth;

FIGS. 2A, 2B and 2C show different schematic views of a dental restoration according to an embodiment of the present disclosure;

FIG. 3 shows a schematic sectional side view of the dental restoration and a prepared tooth according to an embodiment of the present disclosure;

FIG. 4 shows a schematic exploded view of the dental restoration and the prepared tooth according to an embodiment of the present disclosure;

FIG. 5 shows a schematic sectional front view of a dental restoration and the prepared tooth according to another embodiment of the present disclosure;

FIG. 6 shows a flowchart of a method of forming the dental restoration according to an embodiment of the present disclosure; and

FIGS. 7A-7G show schematic views of various steps of forming the dental restoration according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% or +/−10% or +/−5% or +/−2% for quantifiable properties).

The term “substantially”, unless otherwise specifically defined, means to a high degree of approximation (e.g., within +/−10% or +/−5% or +/−2% for quantifiable properties) but again without requiring absolute precision or a perfect match.

The term “about”, unless otherwise specifically defined, means to a high degree of approximation (e.g., within +/−5% or +/−2% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

The term “dental restoration” generally refers to a dental crown for a single tooth or a dental bridge for multiple adjoining teeth.

The term “chair-time” generally refers to an amount of time the patient spends in a chair of a health care provider, for example, a dental practitioner for an examination or a treatment.

As used herein, the term “three-dimensional representation,” refers to any three-dimensional surface map of an object, such as a point cloud of surface data, a set of two-dimensional polygons, or any other data representing all or some of the surface of an object, as might be obtained through the capture and/or processing of three-dimensional scan data, unless a different meaning is explicitly provided or otherwise clear from the context. A “three-dimensional representation” may include volumetric and other representations, unless a different meaning is explicitly provided or otherwise clear from the context.

The present disclosure relates to a method of forming a dental restoration for a tooth having an outer surface. The present disclosure further relates to a dental restoration.

Conventional methods of forming a custom dental restoration include forming a prepared tooth prior to digitally scanning a mouth of a patient to determine dimensions of the prepared tooth in order to generate a design of the custom dental restoration. A digital data file including the design of the custom dental restoration may then be used to form the custom dental restoration. Hence, in conventional methods, a manufacturing process of the custom dental restoration is typically initiated after the tooth is prepared. However, such conventional methods are generally time consuming. The patient may need to wait for a long time before the custom dental restoration is formed and then placed on the prepared tooth. Hence, the conventional methods have a long chair-time. In some cases, multiple visits may be required to finish a dental restoration procedure as forming the custom dental restoration is typically time consuming.

The method of the present disclosure includes acquiring a first three-dimensional representation representative of the outer surface of the tooth. The method further includes generating a design of a first part of the dental restoration based on the first three-dimensional representation of the tooth. The first part includes a first outer surface substantially conforming to at least a first portion of the outer surface of the tooth and a first inner surface spaced apart from the first outer surface. The first inner surface of the first part defines an inner cavity. The method further includes forming the first part of the dental restoration. The method further includes preparing the tooth to form a prepared tooth while forming the first part of the dental restoration. The method further includes obtaining a second three-dimensional representation of the prepared tooth. The method further includes generating a design of a second part of the dental restoration based on at least the second three-dimensional representation of the prepared tooth. The second part of the dental restoration is disposed adjacent to the first part of the dental restoration. The method further includes merging the design of the second part of the dental restoration to the first part of the dental restoration. The method further includes forming the second part of the dental restoration.

The first part of the dental restoration includes an upper surface representative of an upper surface of the tooth. Typically, the upper surface of the tooth is more complex and thus forming the first part of the dental restoration is generally more time consuming than the second part of the dental restoration. Further, forming the first part of the dental restoration may not require the second three-dimensional representation of the prepared tooth. Therefore, the dental practitioner may prepare the tooth while the first part is being formed. In some cases, the dental practitioner may further obtain the second three-dimensional representation of the prepared tooth while the first part is being formed. In some cases, the dental practitioner may also design the second part of the dental crown while the first part is being formed. In some other cases, the design of the second part of the dental crown may be automatically generated while the first part is being formed. The design of the second part of the dental crown may be readily merged or stitched to the first part of the dental crown. As a result, the method of the present disclosure may substantially reduce the chair-time of the patient. Therefore, the dental restoration may be formed and placed on the prepared tooth in a single visit or an appointment.

The second part includes a second outer surface contiguous with the first outer surface and a second inner surface spaced apart from the second outer surface and contiguous with the first inner surface. In other words, the second inner surface is offset from the second outer surface and contiguous with the first inner surface.

The second inner surface defines an opening therethrough disposed in fluid communication with the inner cavity of the first part. The opening is configured to at least partially receive a tooth stump of the prepared tooth therein. The second inner surface is offset from the tooth stump by a substantially constant gap along a length of the opening. A first ratio of a volume of the inner cavity to a volume of the substantially constant gap is greater than or equal to 2.

The dental restoration of the present disclosure further combines features of a shell-type dental restoration and a close-fit of a conventional custom dental restoration. Specifically, the first part of the dental restoration of the present disclosure may resemble a shell-type dental restoration since the first part includes the inner cavity. Therefore, manufacturing complexity and time of the first part may be reduced as compared to conventional custom dental restorations having a close-fit with a prepared tooth. Further, the first outer surface of the first part at least partially conforms to a desired contour of a tooth, thereby providing a degree of customization. Moreover, a manufacturing process of the first part may be initiated before or while the tooth is being prepared, thereby reducing a total manufacturing time of the dental restoration of the present disclosure. Additionally, the second part of the dental restoration of the present disclosure may form a closer fit with the tooth stump of the prepared tooth as compared to the first part. Specifically, the volume of the substantially constant gap is less than the volume of the inner cavity of the first part to allow the closer fit around the tooth stump. Therefore, the dental restoration of the present disclosure may have a desired fit with the tooth stump, while providing the inner cavity of the first part.

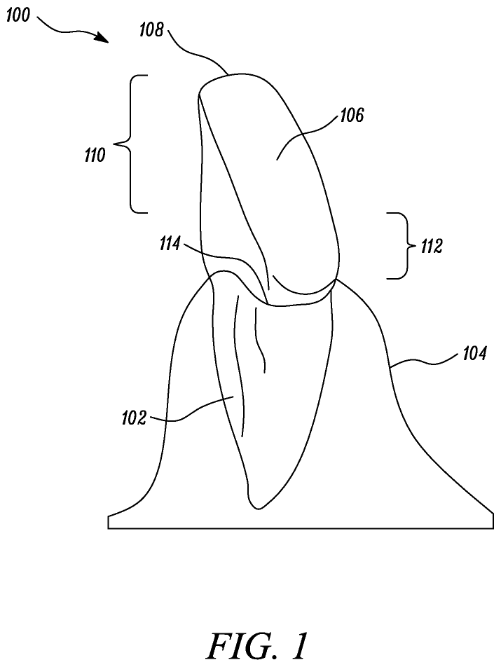

Referring now to figures, FIG. 1 shows a schematic perspective view of a tooth 100 having an outer surface 106. The tooth 100 includes different layers, such as enamel, dentin, pulp, and cementum. In some embodiments, the enamel defines the outer surface 106 of the tooth 100. The outer surface 106 represents an outer contour of the tooth 100. The tooth 100 further includes an upper surface 108. In some embodiments, the upper surface 108 may be an incisal surface or an occlusal surface. The tooth 100 may be an incisor, a canine, or a molar. In the illustrated embodiment of FIG. 1 the tooth 100 is an incisor. Thus, the upper surface 108 is the incisal surface. In some other embodiments, the tooth 100 may be a molar and the upper surface 108 may be the occlusal surface. The outer surface 106 of the tooth 100 further includes a first portion 110 and a second portion 112. The first portion 110 and the second portion include the outer surface 106 of the tooth 100. The tooth 100 further includes a root 102. The root 102 of the tooth 100 extends through a gingiva 104 for anchoring the tooth 100. In the illustrated embodiment of FIG. 1 the tooth 100 includes only one root 102. In some other embodiments, the tooth 100 may include one or more roots 102. The tooth 100 further includes a cementoenamel junction (CEJ) 114. The CEJ is a slightly visible anatomical border on the tooth 100. The cementoenamel junction 114 is a location at which the anatomical crown of the tooth 100 meets the cementum which covers the root 102.

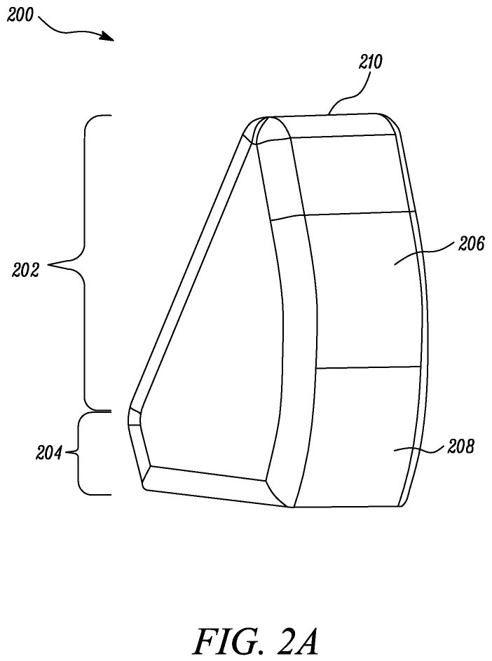

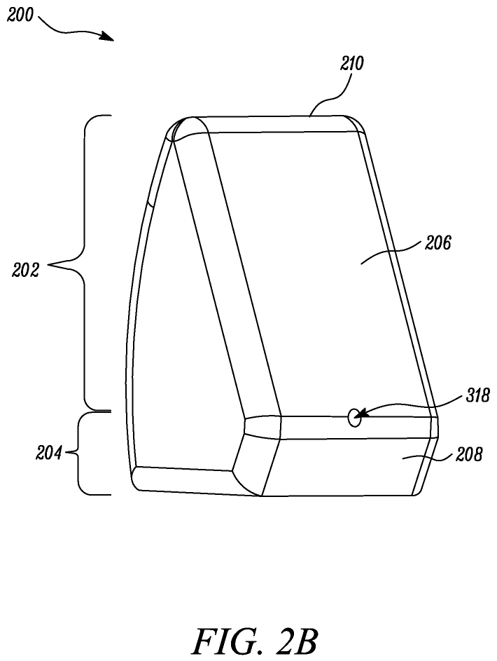

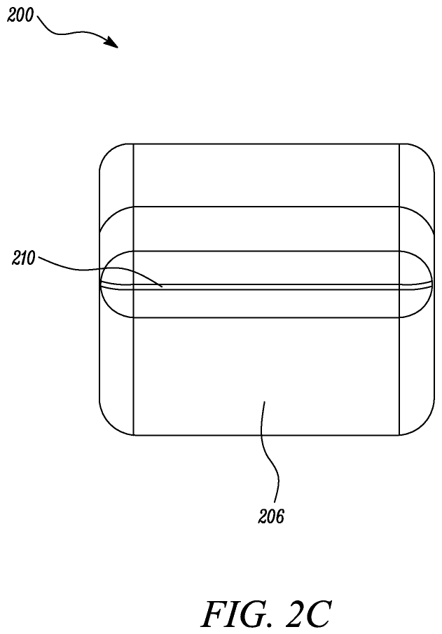

FIGS. 2A-2C, 3 and 4 illustrate a dental restoration 200 according to an embodiment of the present disclosure. In the illustrated embodiments of FIGS. 2A-2C, 3 and 4, the dental restoration 200 is a dental crown. However, in some other embodiments, the dental restoration 200 may be a dental bridge, or the like.

FIGS. 2A, 2B and 2C show different schematic views of the dental restoration 200. The dental restoration 200 includes a first part 202 and a second part 204. The second part 204 of the dental restoration 200 is disposed adjacent to the first part 202. The first part 202 and the second part 204 are integral with each other. In some embodiments, the dental restoration 200 is additively formed in a single step.

The first part 202 of the dental restoration 200 includes a first outer surface 206. The first outer surface 206 substantially conforms to at least the first portion 110 of the outer surface 106 of the tooth 100 shown in FIG. 1. The second part 204 of the dental restoration 200 includes a second outer surface 208 contiguous with the first outer surface 206. In some embodiments, the second outer surface 208 substantially conforms to at least the second portion 112 of the outer surface 106 of the tooth 100 shown in FIG. 1. The first outer surface 206 and the second outer surface 208 together form an outer contour of the dental restoration 200. The outer contour of the dental restoration 200 may substantially conform to the outer surface 106 of the tooth 100 shown in FIG. 1. In some embodiments, the dental restoration 200 further includes an upper surface 210 representative of the upper surface 108 of the tooth 100 shown in FIG. 1. Specifically, the first part 202 of the dental restoration 200 includes the upper surface 210 representative of the upper surface 108 of the tooth 100. In some embodiments, the upper surface 210 includes the incisal surface or the occlusal surface. In the illustrated embodiment of FIGS. 2A, 2B and 2C the dental restoration 200 includes the upper surface 210 including the incisal surface. In some other embodiments, the dental restoration 200 may include the upper surface 210 including the occlusal surface.

In some embodiments, the dental restoration 200 may include materials, such as a dental porcelain, a zirconia, a glass ceramic, a composite material, a ceramic-composite hybrid material, a resin composite, a metal, a computer-aided design (CAD) computer-aided manufacturing (CAM) restorative material, or combinations thereof, but is not limited to the above-mentioned materials. In some embodiments, the dental restoration 200 may include materials similar to those described in U.S. Pat. No. 10,610,330 B2 (Hellmann et al.) the disclosure of which is incorporated by reference in its entirety. In some embodiments, the dental restoration 200 may include a glass, a polycrystalline ceramic material, for example, including alumina (e.g., Al2O3), zirconia (ZrO2), partly or fully stabilized zirconia (e.g., Yttrium-stabilized zirconia), titanium dioxide (TiO2), high-strength oxides of the elements of the main groups II, III and IV and the subgroups III and IV, and their mixtures, metals, metal alloys, precious metals, precious metal alloys, or combinations thereof (e.g., cobalt alloys, such as cobalt-chromium, titanium alloys, gold/platinum/palladium alloys, etc., and combinations thereof).

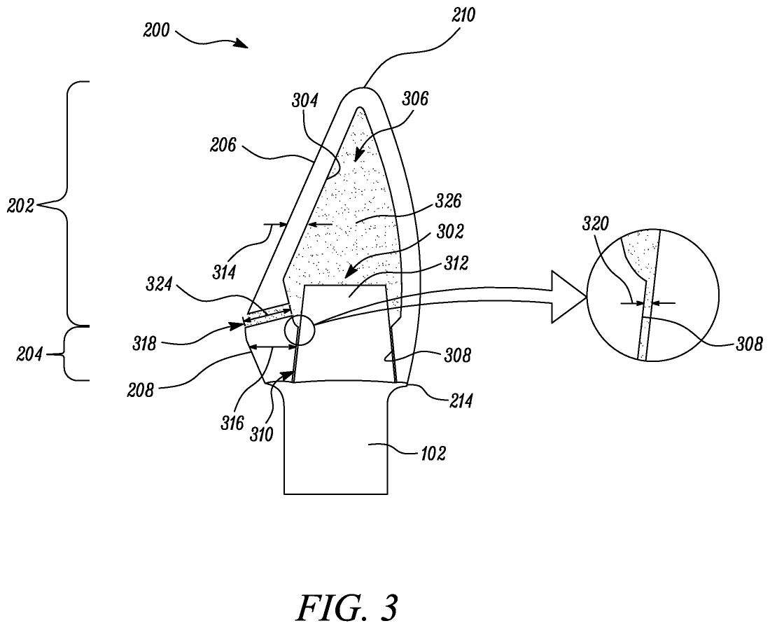

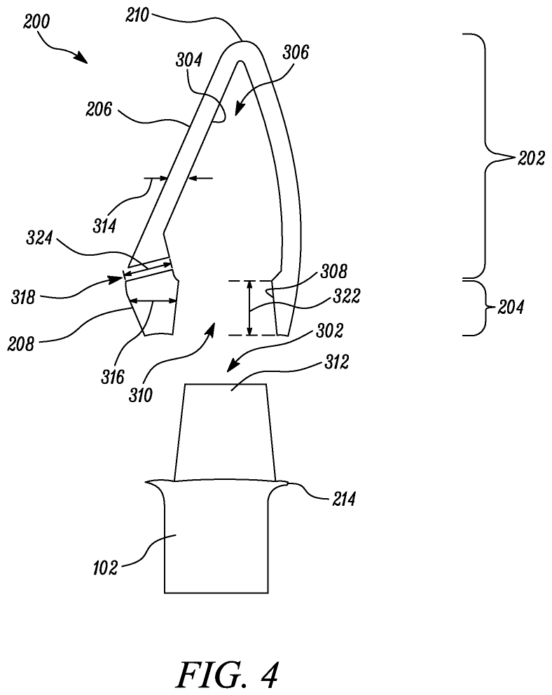

FIG. 3 is a schematic sectional side view of the dental restoration 200 and a prepared tooth 302. FIG. 4 is an exploded view of the dental restoration 200 and the prepared tooth 302.

Referring now to FIGS. 3 and 4, the tooth 100 (shown in FIG. 1) is prepared to form the prepared tooth 302 for receiving the dental restoration 200. In some embodiments, the prepared tooth 302 further includes a tooth stump 312 and a tooth seat 214. The first part 202 and the second part 204 are integral with each other and form the dental restoration 200. The tooth seat 214 may provide a seating surface for the second part 204 of the dental restoration 200.

The first part 202 includes a first inner surface 304 spaced apart from the first outer surface 206. In other words, the first inner surface 304 is offset from the first outer surface 206. The first inner surface 304 defines an inner cavity 306. The second part 204 further includes a second inner surface 308 spaced apart from the second outer surface 208 and contiguous with the first inner surface 304. In other words, the second inner surface 308 is offset from the second outer surface 208 and contiguous with the first inner surface 304.

The second inner surface 308 defines an opening 310 therethrough disposed in fluid communication with the inner cavity 306 of the first part 202. In the illustrated embodiment of FIGS. 3 and 4, the opening 310 has a frustoconical shape. However, in some other embodiments, the opening 310 may have any suitable shape, such as a cylindrical shape, a hemispherical shape, a cuboidal shape, a cubical shape, and so forth. A shape of the opening 310 may be based on a shape of the tooth stump 312. The opening 310 further defines a length 322.

The opening 310 is configured to at least partially receive the tooth stump 312 of the prepared tooth 302 therein. In some embodiments, the opening 310 receives the tooth stump 312 therethrough, such that the tooth stump 312 extends into the inner cavity 306 of the first part 202. In such embodiments, the length 322 of the opening 310 is less than a length of the tooth stump 312. In some other embodiments, a portion of the opening 310 receives the tooth stump 312 therein, such that the tooth stump 312 does not extend into the inner cavity 306 of the first part 202. In such embodiments, the length 322 of the opening 310 may be greater than the length of the tooth stump 312. In some cases, the length 322 of the opening 310 may be substantially equal to the length of the tooth stump 312.

The second inner surface 308 is offset from the tooth stump 312 by a substantially constant gap 320 (hereinafter referred to as “the gap 320”) along the length 322 of the opening 310. In some embodiments, a first ratio of the volume of the inner cavity 306 to a volume of the gap 320 is greater than or equal to 2. In some embodiments, the first ratio may be greater than or equal to 4, greater than or equal to 5, greater than or equal to 6, greater than or equal to 8, or greater than or equal to 10. In some embodiments, the gap 320 is annular. In some embodiments, the gap 320 is from about 5 microns to about 200 microns. In some embodiments, the gap 320 is greater than or equal to about 10, greater than or equal to about 25 microns, greater than or equal to about 50 microns, greater than or equal to about 75 microns, greater than or equal to about 100 microns, greater than or equal to about 125 microns, greater than or equal to about 150 microns, greater than or equal to about 175 microns, or greater than or equal to about 200 microns.

In some cases, the tooth 100 may be a canine or an incisor. In such cases, a volume of the opening 310 may be less than the volume of the inner cavity 306. In some embodiments, a second ratio of the volume of the inner cavity 306 to the volume of the opening 310 is greater than or equal to 2. In some embodiments, the second ratio of the volume of the inner cavity to the volume of the opening is greater than or equal to 3. In some embodiments, the second ratio of the volume of the inner cavity to the volume of the opening is greater than or equal to 4, or greater than or equal to 5. In some other cases, the tooth 100 may be a molar or a pre-molar. In such cases, the volume of the opening 310 may be greater than the volume of the inner cavity 306. In some embodiments, the second ratio of the volume of the inner cavity 306 to the volume of the opening 310 is less than or equal to 0.5. In some embodiments, the second ratio of the volume of the inner cavity 306 to the volume of the opening 310 is less than or equal to 0.4. In some embodiments, the second ratio of the volume of the inner cavity 306 to the volume of the opening 310 is less than or equal to 0.3, or less than or equal to 0.25.

In some embodiments, the first outer surface 206 and the first inner surface 304 define a first average thickness 314 therebetween. In some embodiments, the second outer surface 208 and the second inner surface 308 define a second average thickness 316 therebetween. In some embodiments, a third ratio of the second average thickness 316 to the first average thickness 314 is greater than or equal to 2. In some embodiments, the third ratio of the second average thickness 316 to the first average thickness 314 is greater than or equal to 3, greater than or equal to 4, or greater than or equal to 5. In some embodiments, the first average thickness 314 is from about 100 microns to about 600 microns.

In some embodiments, a fourth ratio of the first average thickness 314 to the gap 320 is greater than or equal to 2. In some embodiments, the fourth ratio of the first average thickness 314 to the gap 320 is greater than or equal to 3, greater than or equal to 4, or greater than or equal to 5.

In some embodiments, the first part 202 further defines at least one passage 318 extending from the first inner surface 304 to the first outer surface 206. In some other embodiments, the second part 204 may also define at least one passage 318 extending from the second inner surface 308 to the second outer surface 208. In some other embodiments, the first part 202 may define at least a portion of the at least one passage 318 and the second part 204 may define at least another portion of the at least one passage 318.

In the illustrated embodiment of FIGS. 3 and 4, the first part 202 includes one passage 318 extending from the first inner surface 304 to the first outer surface 206. In some other embodiments, the first part 202 may include two, three, or four passages extending from the first inner surface 304 to the first outer surface 206. In some embodiments, the first part 202 may include multiple such passages 318 spaced apart from each other. In an example, the passages 318 may be at least angularly spaced from each other. The passages 318 may be identical or different from each other. In some embodiments, the at least one passage 318 is disposed proximal to the second part 204. In some other embodiments, the at least one passage 318 is disposed proximal to the upper surface 210. In some embodiments, the at least one passage 318 is inclined towards the second part 204 when extending from the first inner surface 304 to the first outer surface 206. Specifically, the at least one passage 318 is inclined downwards. In some other embodiments, the at least one passage 318 may be inclined upwards. In some embodiments, the at least one passage 318 may have a substantially circular shape, as shown in FIG. 2B. In some other embodiments, the at least one passage 318 may have any suitable shape, for example, but not limited to, polygonal, elliptical, oval, and so forth.

In some embodiments, the at least one passage 318 has a length 324 from the first inner surface 304 to the first outer surface 206. In some embodiments, a ratio of the length 324 of the at least one passage 318 to the first average thickness 314 is greater than or equal to 1.5. In some embodiments, the ratio of the length 324 of the at least one passage 318 to the first average thickness 314 is greater than or equal to 2.

In some embodiments, the dental restoration 200 further includes a dental material 326 received at least within the inner cavity 306 of the first part 202. In some cases, the dental material 326 may also be received in the gap 320 between the second inner surface 308 and the tooth stump 312. In some embodiments, the dental material 326 is a hardenable dental material. In some embodiments, the dental material 326 is curable. In some embodiments, the gap 320 defined between the second inner surface 308 and the tooth stump 312 may be very small. In such cases, an excess amount of the dental material 326 may be difficult to remove from the inner cavity 306 of the first part 202.

In some embodiments, the excess amount of the dental material 326 may flow out through the at least one passage 318 extending from the first inner surface 304 to the first outer surface 206. In other words, the excess amount of the dental material 326 filled in the dental restoration 200 flows out of the at least one passage 318 when the dental restoration 200 is placed on the prepared tooth 302. Therefore, the at least one passage 318 may reduce difficulty in removing the excess amount of the dental material 326 from the dental restoration 200.

In some embodiments, the dental material 326 may include a resin-based polymer matrix, such as a bisphenol A-glycidyl methacrylate (BISGMA), urethane dimethacrylate (UDMA) or semi-crystalline polyceram (PEX), and an inorganic filler such as silicon dioxide (silica). In some cases, without a filler, the resin wears easily, exhibits high shrinkage and is exothermic. In some embodiments, compositions of the dental material 326 may vary widely, with proprietary mixes of resins forming the matrix, as well as engineered filler glasses and glass ceramics. The filler gives the composite greater strength, wear resistance, decreased polymerization shrinkage, improved translucency, fluorescence and color, and a reduced exothermic reaction on polymerization. The filler may also however cause the resin composite to become more brittle with an increased elastic modulus. Glass fillers are found in multiple different compositions allowing an improvement in the optical and mechanical properties of the material. Ceramic fillers include zirconia-silica and zirconium oxide.

In the illustrated embodiment of FIGS. 2A-2C, 3 and 4, the dental restoration 200 is a dental crown for one tooth. However, the present disclosure can also be extended to dental bridges for multiple teeth, with one or more members of the dental bridge incorporating teachings of the present disclosure.

The dental restoration 200 combines features of a shell-type dental restoration and a close-fit of a conventional custom dental restoration. Specifically, the first part 202 of the dental restoration 200 may resemble a shell-type dental restoration since the first part 202 includes the inner cavity 306. Therefore, manufacturing complexity and time of the first part 202 may be reduced as compared to conventional custom dental restorations having a close-fit with a prepared tooth. Further, the first outer surface 206 of the first part 202 at least partially conforms to a desired contour of the tooth 100, thereby providing a degree of customization. Moreover, a manufacturing process of the first part 202 may be initiated before or while the tooth 100 is being prepared, thereby reducing a total manufacturing time of the dental restoration 200. Additionally, the second part 204 of the dental restoration 200 may form a closer fit with the tooth stump 312 of the prepared tooth 302 as compared to the first part 202. Specifically, the volume of the gap 320 is less than the volume of the inner cavity 306 of the first part 202 to allow the closer fit around the tooth stump 312. Therefore, the dental restoration 200 may have a desired fit with the tooth stump 312, while providing the inner cavity 306 of the first part 202.

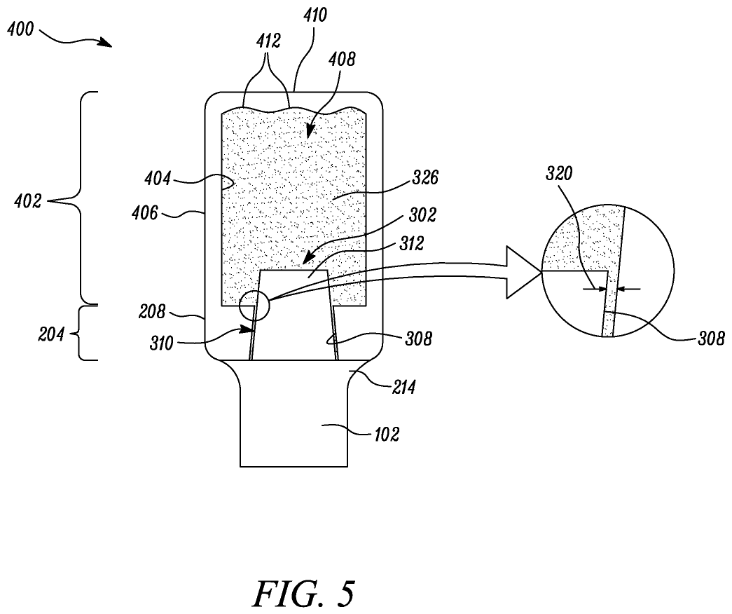

FIG. 5 illustrates a dental restoration 400 according to another embodiment of the present disclosure. Specifically, FIG. 5 is a schematic sectional front view of the dental restoration 400 and the prepared tooth 302. The dental restoration 400 is substantially similar to the dental restoration 200 shown in FIGS. 2A-2C, 3 and 4. However, the dental restoration 400 includes a first part 402 and the second part 204. The second part 204 of the dental restoration 400 is disposed adjacent to the first part 402. The first part 402 and the second part 204 are integral with each other. In other words, the first part 402 and the second part 204 are integral with each other and form the dental restoration 400. The first part 402 of the dental restoration 400 includes a first outer surface 406. The first outer surface 406 substantially conforms to at least the first portion 110 of the outer surface 106 of the tooth 100 shown in FIG. 1. The first part 402 includes a first inner surface 404 spaced apart from the first outer surface 406. In other words, the first inner surface 404 is offset from the first outer surface 406. The first inner surface 404 defines an inner cavity 408. In the illustrated embodiment of FIG. 5, the first inner surface 404 of the first part 402 includes one or more ridges 412 representative of one or more mamelons. In some embodiments, the first part 402 of the dental restoration 400 may include a substantially translucent material. In some embodiments, the dental restoration 400 further includes the dental material 326 received at least within the inner cavity 408 of the first part 402. In some embodiments, the dental material 326 may be substantially opaque. Therefore, the one or more ridges 412 of the dental restoration 400 may closely mimic the appearance of a tooth (for example, the tooth 100) including one or more mamelons.

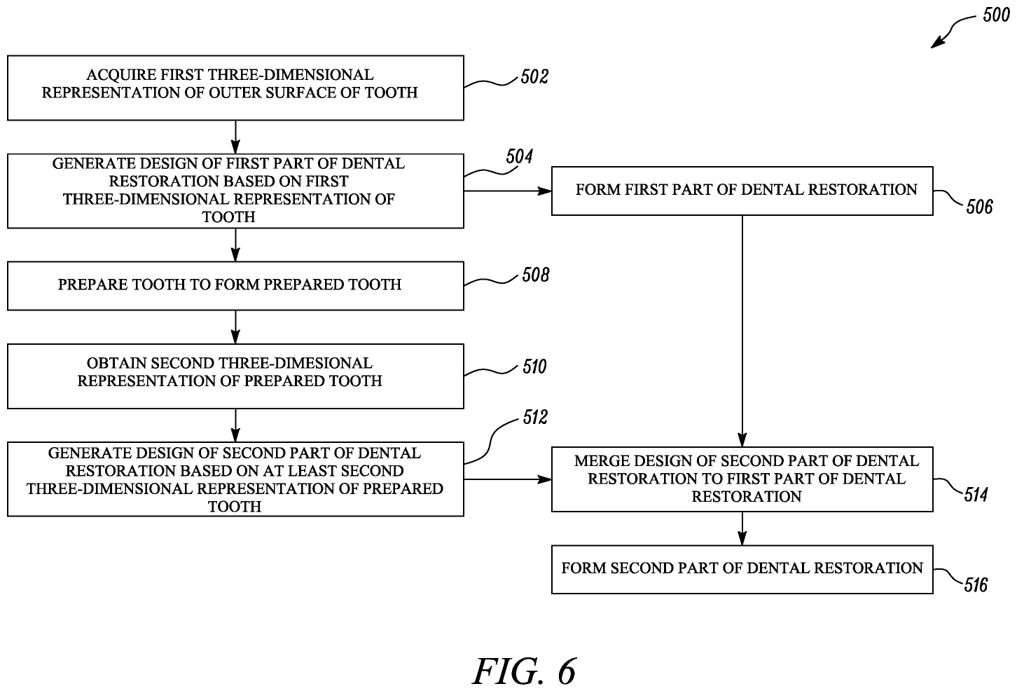

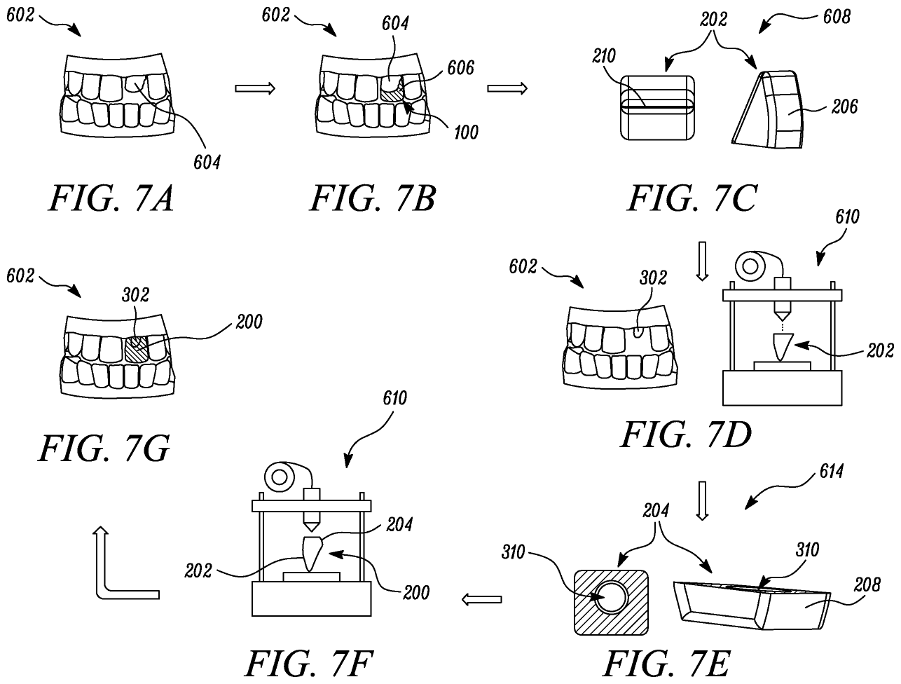

FIG. 6 shows a flowchart of an exemplary method 500 of forming the dental restoration 200 for the tooth 100 having the outer surface 106. The dental restoration 200 is shown in detail in FIGS. 2A-2C, 3 and 4. The method 500 will be described with reference to the dental restoration 200 of FIGS. 2A-2C, 3 and 4. However, a similar method may be followed to form the dental restoration 400 shown in FIG. 5. FIGS. 7A-7G illustrates exemplary steps of forming the dental restoration 200. The method 500 will further be described with reference to FIGS. 7A-7G.

FIG. 7A shows a front view of a mouth 602 of a patient. In some embodiments, the method 500 may include examining the mouth 602 of the patient to determine if a tooth is decayed or disfigured by a dental practitioner. FIG. 7A illustrates a disfigured tooth 604. The disfigured tooth 604 may be substantially similar to the tooth 100 shown in FIG. 1 prior to disfigurement. The dental restoration 200 may be formed for the disfigured tooth 604 shown in FIG. 7A.

In some embodiments, the method 500 may include temporarily restoring the disfigured tooth 604 of the patient as shown in FIG. 7B for a desired final shape of the tooth 604, for example, like the tooth 100 shown in FIG. 1. In some embodiments, temporarily restoring the decayed or disfigured tooth 604 may include placing a repair 606 on the decayed or disfigured tooth 604. In some embodiments, after temporarily restoring the decayed or disfigured tooth 604, the tooth 604 may correspond to the tooth 100.

At step 502, the method 500 includes acquiring a first three-dimensional representation representative of the outer surface 106 of the tooth 100.

In some embodiments, acquiring the first three-dimensional representation further includes optically scanning the tooth 100 to obtain scanned data representative of the outer surface 106 (shown in FIG. 1) of the tooth 100. In some embodiments, acquiring the first three-dimensional representation further includes optically scanning the temporarily restored disfigured tooth 604 which may correspond to the tooth 100. In some embodiments, acquiring the first three-dimensional representation further includes optically scanning a prior restoration corresponding to the tooth 100 and having the outer surface 106. In some embodiments, acquiring the first three-dimensional representation further includes optically scanning a temporarily restored prior restoration corresponding to the tooth 100 and having the outer surface 106.

In some embodiments, optically scanning the tooth 100 further includes performing an intraoral scan. In some embodiments, optically scanning the tooth 100 may include performing a digital data capture, a computed tomography (CT), or a computer-aided tomography (CAT) of the mouth 602 of the patient. In some other embodiments, optically scanning the tooth 100 may include indirectly performing a digital data capture of the mouth 602 of the patient by performing the digital data capture of a plaster model of the mouth 602 of the patient or of a dental impression of the mouth 602 of the patient, rather than directly capturing a three-dimensional structure of the mouth 602 of the patient. In the case of using the dental impression, the digital data capture may be inverted from a negative volume to a positive volume.

In some embodiments, the first three-dimensional representation can be obtained prior to the time or date at which the remaining steps of the method 500 occur.

In some embodiments, acquiring the first three-dimensional representation further includes processing the scanned data to generate the first three-dimensional representation of the tooth 100.

In some other embodiments, acquiring the first three-dimensional representation further includes retrieving the first three-dimensional representation of the tooth 100 from a database. In some other embodiments, acquiring the first three-dimensional representation further includes retrieving the first three-dimensional representation of the tooth 100 from a CAD file. In some embodiments, at least a portion of the first three-dimensional representation may be provided by a series of tooth libraries, or databases, that can be adapted to replicate a portion or all of the tooth 100. Use of the database may be necessary for a severely worn, fractured, or altogether absent tooth, for example, the disfigured tooth 604. In some embodiments, the first three-dimensional representation may be provided by the patient's file history or from a previous digital data capture.

In some other embodiments, the method 500 further includes generating the first three-dimensional representation of the tooth 100 based on at least one other tooth. In other words, generating the first three-dimensional representation of the tooth 100 may include acquiring the first three-dimensional representation of a tooth or teeth in the other half of a jaw of the patient. In some embodiments, generating the first three-dimensional representation of the tooth 100 may include acquiring the first three-dimensional representation of adjacent teeth for defining contact surfaces of the dental restoration 200 to be formed.

At step 504, the method 500 further includes generating a design 608 (shown in FIG. 7C) of the first part 202 of the dental restoration 200 based on the first three-dimensional representation of the tooth 100. As discussed above, the first part 202 includes the first outer surface 206 substantially conforming to at least the first portion 110 (shown in FIG. 1) of the outer surface 106 of the tooth 100 and the first inner surface 304 spaced apart from the first outer surface 206. The design 608 further includes the first part 202 of the dental restoration 200 including the first outer surface 206. FIG. 7C shows both top and perspective views of the design 608.

At step 506, the method 500 further includes forming (shown in FIG. 7D) the first part 202 of the dental restoration 200. In the illustrated embodiment of FIG. 7D, the method 500 further includes additively forming the first part 202. FIG. 7D shows an exemplary additive manufacturing apparatus 610 forming the first part 202 (shown in FIGS. 2A-2C and 3). In some embodiments, the first part 202 may be additively formed using an additive manufacturing technique, such as stereolithography (SLA) in which successive layers of material are laid down by the additive manufacturing apparatus 610 under control of a computer (not shown). In some embodiments, the computer may include a display and one or more user input devices, such as a mouse or a keyboard. In some embodiments, the additive manufacturing apparatus 610 may also include an input device or an output device, such as a control input (e.g., button, touchpad, thumbwheel, etc.), or a display (e.g., LCD or LED display) to provide status information.

Other examples of additive manufacturing techniques include Fused Filament Fabrication (FFF), Powder Bed Fusion (PBF), and the like.

In some embodiments, the method 500 further includes forming the at least one passage 318 (not shown in FIG. 7D) in the first part 202 of the dental restoration 200, such that the at least one passage 318 extends from the first inner surface 304 to the first outer surface 206. In some embodiments, the at least one passage 318 may be included in the design 608 of the first part 202 of the dental restoration 200. In some embodiments, the at least one passage 318 may be formed after the first part 202 is formed, for example, by drilling.

In some other embodiments, the method 500 further includes subtractively forming the first part 202 of the dental restoration 200 from a blank (not shown). In some embodiments, the first part 202 of the dental restoration 200 may be formed by milling. The blank generally refers to a solid block of material from which the dental restoration 200 can be machined. In some embodiments, the blank may have a length of about 15 millimeters (mm) to about 30 mm, or about 40 mm to about 80 mm. In general, the blanks are attached to a support, a stub, or a mandrel that fits into a milling machine (not shown). In some embodiments, the blank may have a rough shape of the outer contour of the dental restoration 200.

Typically, the upper surface 108 of the tooth 100 is more complex and thus forming the first part 202 including the upper surface 210 representative of the upper surface 108 of the tooth 100 is generally more time consuming.

At step 508, the method 500 further includes preparing the tooth 604 to form the prepared tooth 302 (shown in FIG. 7D) while forming the first part 202 of the dental restoration 200. In some embodiments, preparing the tooth 604 to form the prepared tooth 302 further includes forming the tooth stump 312 and the tooth seat 214 (shown in FIG. 3). Since, forming the first part 202 including the upper surface 210 representative of the upper surface 108 of the tooth 100 is generally more time consuming, the dental practitioner may prepare the tooth 604 to form the prepared tooth 302 while the first part 202 of the dental restoration 200 is being formed. This may substantially reduce the chair-time of the patient. Forming of the first part 202 may be initiated prior to or while the tooth 100 is being prepared.

FIG. 7D shows the tooth 604 being prepared to form the prepared tooth 302 while the additive manufacturing apparatus 610 is forming the first part 202 of the dental restoration 200. In some embodiments, all undercuts present in the prepared tooth 302 may be eliminated using an appropriate buildup or filler materials.

At step 510, the method 500 further includes obtaining a second three-dimensional representation of the prepared tooth 302. In some embodiments, obtaining the second three-dimensional representation further includes optically scanning the prepared tooth 302. In some embodiments, optically scanning the prepared tooth 302 further includes performing an intraoral scan. In some embodiments, the dental practitioner may further obtain the second three-dimensional representation of the prepared tooth 302 while the first part 202 is being formed. This may further reduce the chair-time of the patient.

At step 512, the method 500 further includes generating a design 614 (shown in FIG. 7E) of the second part 204 of the dental restoration 200 based on at least the second three-dimensional representation of the prepared tooth 302. In some embodiments, the method 500 further includes determining if an average thickness (e.g., the second average thickness 316) of the second part 204 is greater than a predetermined thickness. In some embodiments, the predetermined thickness may be a minimum thickness required for forming the dental restoration 200. In some embodiments, the minimum thickness may be less than about 400 microns, less than about 300 microns, less than about 200 microns, or less than about 100 microns. In some embodiments, the method 500 may include generating an alert or a notification if the average thickness of the second part 204 is less than the predetermined thickness. In some embodiments, the design 614 of the second part 204 of the dental restoration 200 is generated further based on the first three-dimensional representation. For example, the design 614 of the second part 204 of the dental restoration 200 may include scanned data representative of the outer surface 106 of the tooth 100. Specifically, the design 614 of the second part 204 of the dental restoration 200 may include scanned data representative of the outer surface 106 of the second portion 112 of the tooth 100. In some embodiments, the at least one passage 318 may be included in the design 614 of the second part 204 of the dental restoration 200. In some embodiments, the at least one passage 318 may be formed after the second part 204 is formed, for example, by drilling. FIG. 7E shows both top and perspective views of the design 614 of the second part 204 of the dental restoration 200.

In some embodiments, the design 614 of the second part 204 of the dental restoration 200 is generated while the first part 202 is being formed. This may further reduce the chair-time of the patient.

In some embodiments, the design 614 of the second part 204 of the dental restoration 200 is generated after the first part 202 of the dental restoration 200 is formed.

At step 514, the method 500 further includes merging the design 614 of the second part 204 to the first part 202. The design 614 of the second part 204 is merged to the first part 202 such that the second part 204 of the dental restoration 200 is disposed adjacent to the first part 202 of the dental restoration 200. In some embodiments, merging the design 614 of the second part 204 to the first part 202 may include superimposing the design 614 of the second part 204 to the first part 202. In some embodiments, merging the design 614 of the second part 204 to the first part 202 may include aligning or orienting the design 614 of the second part 204 to the first part 202. In some embodiments, merging the design 614 of the second part 204 to the first part 202 may include merging a design data of the first part 202 with a design data of the second part 204. In some cases, a smoothing process may be carried out at an interface of the design 614 of the second part 204 and the design 608 of the first part 202.

At step 516, the method 500 further includes forming the second part 204 of the dental restoration 200 (shown in FIG. 7F). In some embodiments, the second part 204 is formed if the determined average thickness of the second part 204 is greater than the predetermined thickness. In some embodiments, forming the second part 204 of the dental restoration 200 further includes additively forming the second part 204. FIG. 7F illustrates the additive manufacturing apparatus 610 forming the second part 204 including the second outer surface 208 (shown in FIG. 3) contiguous with the first outer surface 206 (shown in FIG. 3) of the first part 202 to form the dental restoration 200. In other words, the dental restoration 200 includes the first part 202 and the second part 204 having the first outer surface 206 and the second outer surface 208, respectively, substantially conforming to the outer surface 106 of the tooth 100. In some embodiments, the at least one passage 318 may be formed after the dental restoration 200 is formed, for example, by drilling.

In some other embodiments, forming the second part 204 of the dental restoration 200 further includes subtractively forming the second part 204 of the dental restoration 200 from a blank (not shown). In some embodiments, the second part 204 is formed on the blank including the first part 202.

Therefore, in some embodiments, the dental restoration 200 is additively formed based on the first three-dimensional representation representative of the outer surface 106 of the tooth 100 and the second three-dimensional representation of the prepared tooth 302. In some other embodiments, the dental restoration 200 is subtractively formed based on the first three-dimensional representation representative of the outer surface 106 of the tooth 100 and the second three-dimensional representation of the prepared tooth 302.

The method 500 of forming the dental restoration 200 may enable adding complex three-dimensional features of the inner surface of the tooth 100, such as mamelons, in the dental restoration 200. Thus, the dental restoration 200 may closely mimic the appearance of the tooth 100. Further, the outer contour of the dental restoration 200 may be substantially similar to the outer surface 106 of tooth 100.

In addition, the overall size and shape of the first part 202, the second part 204, and the opening 310 may be varied conveniently, as per the requirements of the patient. Further, materials used for forming the dental restoration 200 may be varied conveniently to suit applications having varying color, shape, and stiffness requirements.

In some embodiments, the method 500 further includes filling at least the inner cavity 306 of the first part 202 with the dental material 326.

In some embodiments, the method 500 further includes placing the dental restoration 200 with the dental material 326 on the prepared tooth 302, such that the second part 204 of the dental restoration 200 at least partially receives the prepared tooth 302 therein (shown in FIG. 7G). The second part 204 of the dental restoration 200 is configured to be placed on the tooth seat 214 (shown in FIG. 3).

In some embodiments, the gap 320 defined between second inner surface 308 and the tooth stump 312 may be very small. In such cases, removing the excess amount of the dental material 326 may be difficult. In some embodiments, the method 500 further includes removing the excess amount of the dental material 326 through the at least one passage 318. Therefore, the at least one passage 318 may substantially reduce difficulty in removing the excess amount of the dental material 326.

In some embodiments, the method 500 includes curing the dental material 326. Specifically, the method 500 includes curing the dental material 326 for a predetermined time period. In some embodiments, the predetermined time period may be at least about 20 seconds, at least about 30 seconds, at least about 40 seconds, at least about 50 seconds, or at least about 60 seconds.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Illustrative embodiments of the invention are described below:
1. A method of forming a dental restoration for a tooth having an outer surface, the method comprising:
   acquiring a first three-dimensional representation representative of the outer surface of the tooth;
   generating a design of a first part of the dental restoration based on the first three-dimensional representation of the tooth, wherein the first part comprises a first outer surface substantially conforming to at least a first portion of the outer surface of the tooth and a first inner surface spaced apart from the first outer surface, and wherein the first inner surface of the first part defines an inner cavity;
   forming the first part of the dental restoration;
   preparing the tooth to form a prepared tooth while forming the first part of the dental restoration;
   obtaining a second three-dimensional representation of the prepared tooth;
   generating a design of a second part of the dental restoration based on at least the second three-dimensional representation of the prepared tooth, wherein the second part of the dental restoration is disposed adjacent to the first part of the dental restoration;
   merging the design of the second part of the dental restoration to the first part of the dental restoration; and
   forming the second part of the dental restoration.
2. The method of embodiment 1, wherein acquiring the first three-dimensional representation further comprises optically scanning the tooth to obtain scanned data representative of the outer surface of the tooth.
3. The method of any of the above embodiments, wherein optically scanning the tooth further comprises performing an intraoral scan.
4. The method of any of the above embodiments, wherein acquiring the first three-dimensional representation further comprises processing the scanned data to generate the first three-dimensional representation.
5. The method of any of the above embodiments, wherein acquiring the first three-dimensional representation further comprises retrieving the first three-dimensional representation from a database or a computer-aided design (CAD) file.
6. The method of any of the above embodiments, wherein acquiring the first three-dimensional representation further comprises generating the first three-dimensional representation based on at least one other tooth.
7. The method of any of the above embodiments, wherein obtaining the second three-dimensional representation further comprises optically scanning the prepared tooth.
8. The method of any of the above embodiments, wherein the design of the second part of the dental restoration is generated further based on the first three-dimensional representation.
9. The method of any of the above embodiments, wherein forming the first part of the dental restoration further comprises additively forming the first part.
10. The method of any of the above embodiments, wherein forming the second part of the dental restoration further comprises additively forming the second part.
11. The method of any of the above embodiments, wherein forming the first part of the dental restoration further comprises subtractively forming the first part from a blank.
12. The method of any of the above embodiments, wherein forming the second part of the dental restoration further comprises subtractively forming the second part from a blank.
13. The method of any of the above embodiments, wherein the first part of the dental restoration comprises an upper surface representative of an upper surface of the tooth.
14. The method of any of the above embodiments, wherein the upper surface of the tooth comprises an occlusal surface or an incisal surface.
15. The method of claim 1, wherein the first inner surface of the first part comprises one or more ridges representative of one or more mamelons.
16. The method of any of the above embodiments, wherein the second part of the dental restoration comprises a second outer surface substantially conforming to at least a second portion of the outer surface of the tooth and a second inner surface spaced apart from the second outer surface, and wherein the second inner surface is configured to at least partially receive the prepared tooth therein.
17. The method of any of the above embodiments, further comprising filling at least the inner cavity of the first part with a dental material.
18. The method of any of the above embodiments, further placing the dental restoration with the dental material on the prepared tooth, such that the second part of the dental restoration at least partially receives the prepared tooth therein.
19. The method of any of the above embodiments, further comprises curing the dental material.
20. The method of any of the above embodiments, further comprises forming at least one passage in the first part of the dental restoration, such that the at least one passage extends from the first inner surface to the first outer surface.
21. The method of any of the above embodiments, further comprises removing an excess amount of the dental material through the at least one passage.
22. The method of any of the above embodiments, wherein the second part of the dental restoration defines an opening therethrough, and wherein the opening is configured to receive the prepared tooth therethrough.
23. The method of any of the above embodiments, preparing the tooth to form the prepared tooth further comprises forming a tooth stump and a tooth seat, wherein the second part of the dental restoration is configured to be placed on the tooth seat.
24. The method of any of the above embodiments, wherein the second inner surface is offset from the tooth stump by a substantially constant gap along a length of the opening.
25. The method of any of the above embodiments, wherein the design of the second part of the dental restoration is generated while the first part is being formed.
26. The method of any of the above embodiments, wherein the design of the second part of the dental restoration is generated after the first part is formed.
27. The method of any of the above embodiments, further comprising determining if an average thickness of the second part is greater than a predetermined thickness.
28. A dental restoration for a tooth having an outer surface, the tooth being prepared to form a prepared tooth for receiving the dental restoration, the dental restoration comprising:
   a first part comprising a first outer surface and a first inner surface spaced apart from the first outer surface, wherein the first outer surface conforms to at least a first portion of the outer surface of the tooth, and wherein the first inner surface defines an inner cavity; and
   a second part disposed adjacent to the first part, the second part comprising a second outer surface contiguous with the first outer surface and a second inner surface spaced apart from the second outer surface and contiguous with the first inner surface;
   wherein the second inner surface defines an opening therethrough disposed in fluid communication with the inner cavity of the first part, wherein the opening is configured to at least partially receive a tooth stump of the prepared tooth therein, and wherein a first ratio of a volume of the inner cavity to a volume of the opening is greater than or equal to 2.
29. The dental restoration of any the previous embodiment, wherein the second outer surface substantially conforms to at least a second portion of the outer surface of the tooth.
30. The dental restoration of any of the above embodiments, wherein a second ratio of the volume of the inner cavity to a volume of the opening is greater than or equal to 2.
31. The dental restoration of any of the above embodiments, wherein a second ratio of the volume of the inner cavity to a volume of the opening is less than or equal to 0.5.
32. The method of any of the above embodiments, wherein the first inner surface of the first part comprises one or more ridges representative of one or more mamelons.
33. The dental restoration of any of the above embodiments, wherein the first outer surface and the first inner surface define a first average thickness therebetween, wherein the second outer surface and the second inner surface define a second average thickness therebetween, and wherein a third ratio of the second average thickness to the first average thickness is greater than or equal to 2.
34. The dental restoration of any of the above embodiments, wherein the substantially constant gap is from about 5 microns to about 200 microns.
35. The dental restoration of any of the above embodiments, wherein the substantially constant gap is annular.
36. The dental restoration of any of the above embodiments, wherein a fourth ratio of the first average thickness to the substantially constant gap is greater than or equal to 2.
37. The dental restoration of any of the above embodiments, wherein the first average thickness is from about 100 microns to about 200 microns.
38. The dental restoration of any of the above embodiments, wherein the opening has a frustoconical shape.
39. The dental restoration of any of the above embodiments, wherein the opening receives the tooth stump therethrough, such that the tooth stump extends into the inner cavity of the first part.
40. The dental restoration of any of the above embodiments, wherein the first part further defines at least one passage extending from the first inner surface to the first outer surface.
41. The dental restoration of any of the above embodiments, wherein the at least one passage has a length from the first inner surface to the first outer surface, and wherein a ratio of the length of the at least one passage to the first average thickness is greater than or equal to 1.5.
42. The dental restoration of any of the above embodiments, wherein the at least one passage is disposed proximal to the second part.
43. The dental restoration of any of the above embodiments, wherein the at least one passage is inclined towards the second part when extending from the first inner surface to the first outer surface.
44. The dental restoration of any of the above embodiments, further comprising a dental material received at least within the inner cavity of the first part.
45. The dental restoration of any of the above embodiments, wherein the dental material is a hardenable material.
46. The dental restoration of any of the above embodiments, wherein the dental restoration is additively formed based on a first three-dimensional representation representative of the outer surface of the tooth and a second three-dimensional representation of the prepared tooth.
47. The dental restoration of any of the above embodiments, wherein the dental restoration is additively formed in a single step.

1. A method of forming a dental restoration for a tooth having an outer surface, the method comprising:
acquiring a first three-dimensional representation representative of the outer surface of the tooth;
generating a design of a first part of the dental restoration based on the first three-dimensional representation of the tooth, wherein the first part comprises a first outer surface substantially conforming to at least a first portion of the outer surface of the tooth and a first inner surface spaced apart from the first outer surface, and wherein the first inner surface of the first part defines an inner cavity;
forming the first part of the dental restoration while the tooth is prepared to form a prepared tooth;
obtaining a second three-dimensional representation of the prepared tooth;
generating a design of a second part of the dental restoration based on at least the second three-dimensional representation of the prepared tooth, wherein the second part of the dental restoration is disposed adjacent to the first part of the dental restoration;
merging the design of the second part of the dental restoration to the first part of the dental restoration; and
forming the second part of the dental restoration.

2. The method of claim 1, wherein acquiring the first three-dimensional representation further comprises optically scanning the tooth to obtain scanned data representative of the outer surface of the tooth.

3. The method of claim 2, wherein optically scanning the tooth further comprises performing an intraoral scan.

4. The method of claim 2, wherein acquiring the first three-dimensional representation further comprises processing the scanned data to generate the first three-dimensional representation.

5. The method of claim 1, wherein acquiring the first three-dimensional representation further comprises retrieving the first three-dimensional representation from a database or a computer-aided design (CAD) file.

6. The method of claim 1, wherein acquiring the first three-dimensional representation further comprises generating the first three-dimensional representation based on at least one other tooth.

7. The method of claim 1, wherein obtaining the second three-dimensional representation further comprises optically scanning the prepared tooth.

8. The method of claim 1, wherein the design of the second part of the dental restoration is generated further based on the first three-dimensional representation.

9. The method of claim 1, wherein forming the first part of the dental restoration further comprises additively forming the first part.

10. The method of claim 1, wherein forming the second part of the dental restoration further comprises additively forming the second part.

11. A dental restoration for a tooth having an outer surface, the tooth being prepared to form a prepared tooth for receiving the dental restoration, the dental restoration comprising:
a first part comprising a first outer surface and a first inner surface spaced apart from the first outer surface, wherein the first outer surface conforms to at least a first portion of the outer surface of the tooth, and wherein the first inner surface defines an inner cavity; and
a second part disposed adjacent to the first part, the second part comprising a second outer surface contiguous with the first outer surface and a second inner surface spaced apart from the second outer surface and contiguous with the first inner surface;
wherein the second inner surface defines an opening therethrough disposed in fluid communication with the inner cavity of the first part, wherein the opening is configured to at least partially receive a tooth stump of the prepared tooth therein, and wherein a first ratio of a volume of the inner cavity to a volume of the opening is greater than or equal to 2.

12. The dental restoration of claim 11, wherein the second outer surface substantially conforms to at least a second portion of the outer surface of the tooth.

13. The dental restoration of claim 11, wherein a second ratio of the volume of the inner cavity to a volume of the opening is greater than or equal to 2.

14. The dental restoration of claim 11, wherein a second ratio of the volume of the inner cavity to a volume of the opening is less than or equal to 0.5.

15. The method of claim 11, wherein the first inner surface of the first part comprises one or more ridges representative of one or more mamelons.
